(19) United States
(12) Patent Application Publication
(10) Pub. No.: US 2008/0022380 A1
(43) Pub. Date: Jan. 24, 2008

(54) METHOD OF PATCHING APPLICATIONS ON SMALL RESOURCE-CONSTRAINED SECURE DEVICES

(75) Inventors: HongQian Karen Lu, Austin, TX (US); Asad Ali, Austin, TX (US); Apostol Vassilev, Austin, TX (US); Michael A. Montgomery, Austin, TX (US); Michael David Hutchinson, Austin, TX (US)

Correspondence Address: THE JANSSON FIRM, 9501 N. CAPITAL OF TX HWY #202, AUSTIN, TX, 78759, US

(73) Assignee: Gemalto, Inc., Austin, TX (US)

(21) Appl. No.: 11/753,379

(22) Filed: May 24, 2007

Related U.S. Application Data
(60) Provisional application No. 60/803,181, filed on May 25, 2006.

(51) Int. Cl. G06F 7/04

(52) U.S. Cl. 726/9

(57) ABSTRACT

Patching of software application. A software application is stored on a smart card as partitions and is loaded from the smart card into the memory of a host computer to which the smart card is connected. The software application is executed on the host computer; which using the instructions of the software application establishes a communications channel between the software application and a remote patch server containing a patch for at least one partition of the software application. Upon detecting that a patch is available for the at least one partition of the software application, downloading the at least one partition from the remote server into volatile memory allocated to the software application on the host computer via the first communications channel, and uploading the at least one partition from the volatile memory allocated to the software application to the smart card. Other systems and methods are disclosed.

### CROSS-REFERENCE TO RELATED APPLICATIONS

This application is a non-provisional application claiming priority from provisional application Ser. No. 60/803,181, filed on 25 May 2006, entitled “A Method of Patching Applications on Small Resource-Constrained Secure Devices,” the teachings of which are incorporated by reference herein as if reproduced in full below.

### BACKGROUND OF THE INVENTION

The present invention relates generally to updating of software applications on a computer, and more particularly to updating of software applications that are loaded onto the computer from a smart card for execution on a computer to which the smart card is connected.

There are two mainstream situations where patching is currently used. For PC and other large platforms, many programs have mechanisms for patching existing programs. Often programs check for patches when they run, or when the computer on which the program is executing is first booted up. Space is no problem for large platforms, e.g., personal computers, so typically the patch or even a complete installer for a new version may be downloaded and stored on the computer. Often the patches or installers are signed with a digital certificate, and the user is asked validate the signing certificate. After validation, the patch is installed or the installer is executed. In the unlikely event that the computer loses power during the installation process, there is often no mechanism for recovery and no need for a recovery process. Rather, the user is expected to reinstall the original version of the program, and repeat the patch process.

For small platforms devices, such as routers and modems, there is typically not enough room to store the patch or installer along with the original program. An installer runs on a host computer, and gives urgent instructions to the user performing the download to not interrupt the patching process. The host computer downloads the patch to the router or small platform, and the patch is installed as it is being downloaded from a server. If the patch is interrupted due to loss of power or loss of connection, sometimes the router or modem is left in an inconsistent state. In some cases, a recovery program is provided to attempt to reload the entire memory of the platform to get to a consistent state, but this may fail if the small platform does not have enough consistency to even connect to the recovery program. The fallback is to send the small platform back to the manufacturer to reload the memory.

Large platforms typically depend only on signing for security. There is rarely any definitive check of the download source or network security other than perhaps HTTPS protocol.

Small platforms rarely have any security provisions in place at all. If an unauthorized version of the host installer is run, that installer can configure the memory to any state whatsoever. Patches are rarely signed; thus, there is a risk of manipulation of the legitimate installer to install a bogus patch program.

Co-pending and co-assigned U.S. patent application Ser. No. 11/564,121 entitled “Method and System of Providing Security Using a Secure Device” describes a method described a method of using smart cards without smart card infrastructure. The method facilitates deployment of smart cards on end user PCs under restricted user privileges. It does not require installation of any additional driver or any changes to the host PC configuration. FIGS. 1 through 4 illustrate the overall architecture and approach of this approach.

The architecture proposed in the co-pending application partitions a smart card application into two main logical components—a Host Agent and a Card Agent. These two agents communicate through a secure channel using the USB Mass Storage device interface. The smart card stores all confidential data, such as private keys and user credentials in a secure file system of the smart card. The smart card also provides cryptographic functionalities related to the confidential data. The host agent interacts with applications in the outside world; for example, a web browser on a user's PC or a remote web server over the Internet. To ensure security and ease of deployment, the host agent resides on the smart card, but is executed in the runtime environment of the user's PC.

A software module such as the host agent that is stored on a smart card and uploaded to a PC for execution may also be required to be updated, i.e., patched, from time-to-time. However, a smart card, i.e., the repository for the host agent executable code, is a prime example of a small platform in which there may not be sufficient resources, notably memory resources, to perform patches of the software module by the traditional methods of patching.

From the foregoing it will be apparent that there is still a need for an improved method to provide secure and efficient patches for software programs that are stored on a resource constrained device, e.g., a smart card, but that is intended for execution on a host computer to which the resource constrained device is attached.

### BRIEF DESCRIPTION OF THE DRAWINGS

FIG. 1 is a block diagram illustrating an example scenario in which a smart card is used to access services on a remote server.

FIG. 2 is a block diagram illustrating a high-level view of the architecture of a smart card of FIG. 1.

FIG. 3 is a block diagram illustrating the architectural organization of programs over the hardware components of the smart card FIG. 2, including illustrating a host agent and card agent both stored in memory of the smart card.

FIG. 4 is a block diagram illustrating the loading of the host-agent of FIG. 3 into Random Access Memory (RAM) of the host computer to which the smart card is connected.

FIG. 5 is a block diagram illustrating one example of such a partition of the host agent.

FIG. 6 is a block diagram illustrating an example scenario in which a smart card is used to access services on a remote server and in which a host computer, running a host agent, may retrieve patches from a patch server running on a remote patch server computer.

FIG. 7 is a timing sequence diagram illustrating the message flow between the remote patch server, the host agent and the card agent to achieve patching of the host agent.

FIG. 8 is a timing sequence diagram illustrating a deferred replacement approach to updating the host agent.

FIG. 9 is a timing sequence diagram illustrating a dynamic replacement approach to updating the host agent.

FIG. 10 is a flow-chart illustrating one embodiment for recovery from tearing.

FIG. 11 is a timing sequence diagram illustrating the customization of the downloader program for use with a particular card.

FIG. 12 is a timing sequence diagram illustrating the operation of the downloader program.

FIG. 13 is a timing sequence diagram illustrating the mechanism of using embedded secret hash values to verify the authenticity of the host agent and the partitions that make up the host agent.

### DETAILED DESCRIPTION OF THE INVENTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

In an embodiment of the invention, a software program that is stored on a security device, or other small device, and that is intended for execution on a host computer to which the security device is connected may be updated, i.e., patched, within the limited memory resources available on the security device even if the memory resources are too small to allow for a complete download and replacement of the complete software program. The method and system disclosed herein provides for a secure and flexible patching of such software applications and provide for recovery from power failure or other interruption of the patching process. Implementation of the patching system described herein adds little overhead to the runtime performance and to the non-volatile memory resource of the smart card.

A security device according to an embodiment of the invention provides a self-contained infrastructure that is automatically shared with a host computer to which the security device is connected. The security device, hereinafter, for illustrative purposes, a smart card, is configured to be connected to a host computer using a standard peripheral connection and to behave as a device normally connected to such a standard peripheral connection. The smart card communicates with the host computer using the communications protocol associated with the standard peripheral connection. In a preferred embodiment, that connection is a Universal Serial Bus (USB) connection and the smart card appears to the host computer as a USB mass storage device. As such, the smart card communicates with the host computer using the USB mass storage protocol. Upon connecting the security device to a host computer, a special program, the host-agent, stored on the smart card, is automatically launched on the host computer. In conjunction with launching the host-agent on the host computer, a corresponding program, the card-agent, is launched on the smart card. The host-agent and card-agent communicate over a special communications protocol for providing secure communications there between. That special communications protocol is carried over the USB mass storage protocol.

By providing a standard hardware interface, one that is available on virtually every modem computer, and by communicating over a standard protocol, while providing the host-agent and card-agent functionality, a smart card according to the invention, may provide a hitherto unavailable advantage of providing the security functionality of a smart card without requiring any special hardware or software on the host computer. Thus, a person carrying such a smart card may achieve the hitherto unavailable advantage of connecting that smart card to virtually any computer, e.g., one provided in a public place, a friend or co-worker's computer, or even, a totally untrusted computer, and achieve a secure communication between the smart card and a remote service. Availability of such smart cards makes new uses of smart cards possible because there is no longer a requirement of a special card reader or middleware.

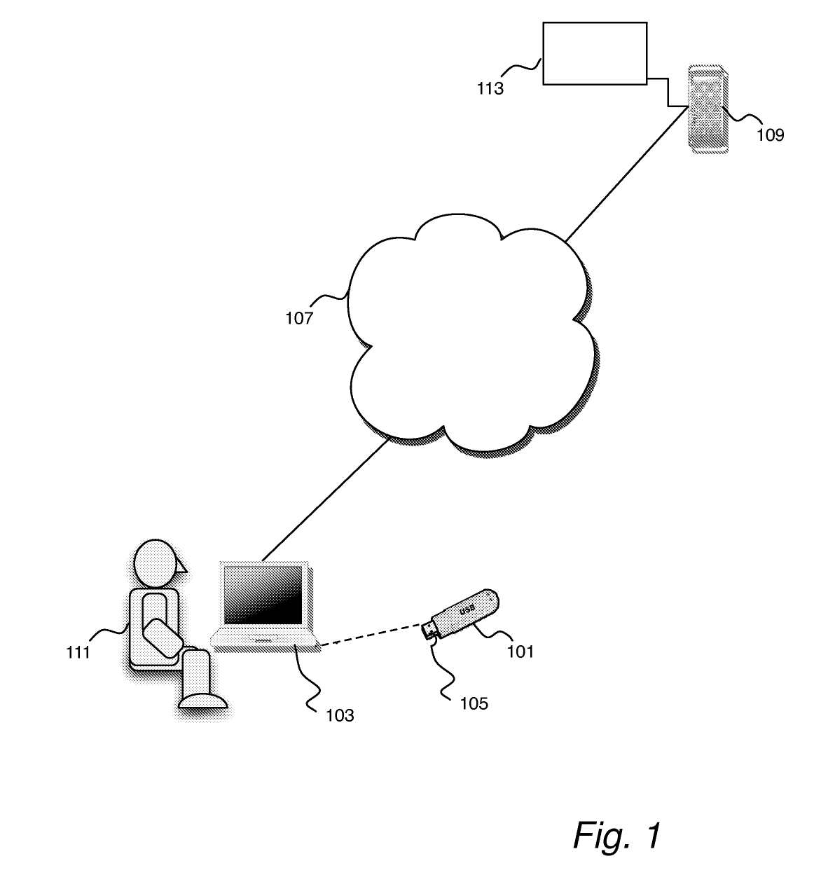

FIG. 1 is a block diagram illustrating an example scenario in which a smart card is used to access services on a remote server. A smart card 101 is connected to a host computer 103 using a standard connector 105. The host computer 103, in turn, is connected to a network 107, e.g., the Internet. At a remote location on the network 107, a server computer 109 is connected. A user 111, for example, the owner of the smart card 101, wishes to access a service 113 provided by the server 109. Consider, as an example, that the service 113 requires the user 111 to identify himself using a PIN. The user 111 (or a service provider) has previously stored the user's PIN on the smart card 101. If the user 111 cannot trust the computer 103, there is a risk that the computer 103 would capture the PIN, if the user merely types in the PIN using the keyboard of the computer 103. Alternatively, the user can direct the smart card 101 to transmit the PIN directly to the remote service 113. That also is problematic. Malware installed on the computer 103 or elsewhere on the path between the smart card 101 and the remote service 113 may capture the PIN by snooping on the communication.

As will be discussed in greater detail below, in one embodiment of the invention, the PIN is securely transmitted to the remote service over a secure communications channel. No special hardware or software is required to be preinstalled on the remote server 109, the host computer 103, or anywhere along the path between the smart card 101 and the remote service 113.

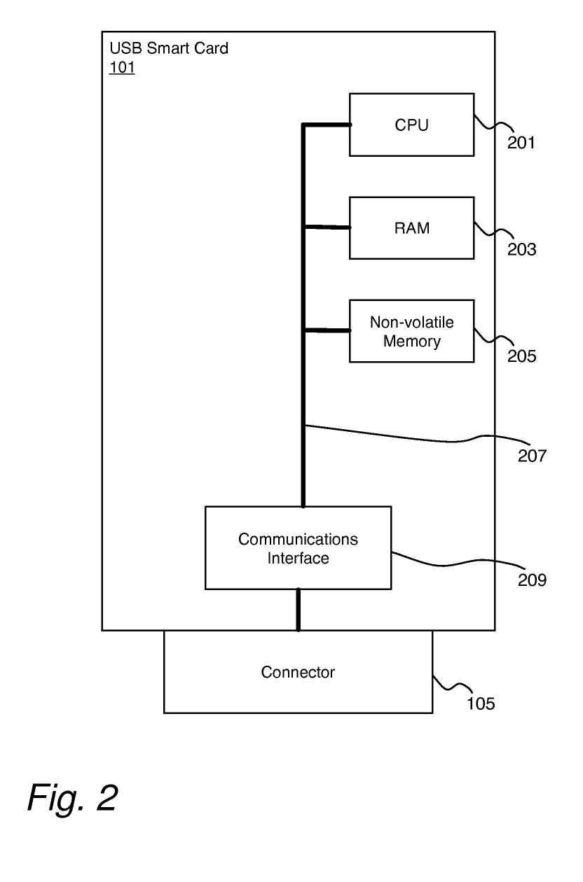

FIG. 2 is a block diagram illustrating a high-level view of the architecture of a smart card 101. As illustrated in FIG. 1, the smart card 101 is equipped with a standard peripheral hardware connector 105, e.g., a USB connector. The smart card 101 contains a central processing unit 201, a RAM 203, and a non-volatile memory 205. These components are connected via a bus 207. Also connected to the bus 207 is a communications hardware interface 209 for providing a connection between the bus 207, and consequently, the CPU 201, RAM 203, and non-volatile memory 205, and the connector 105.

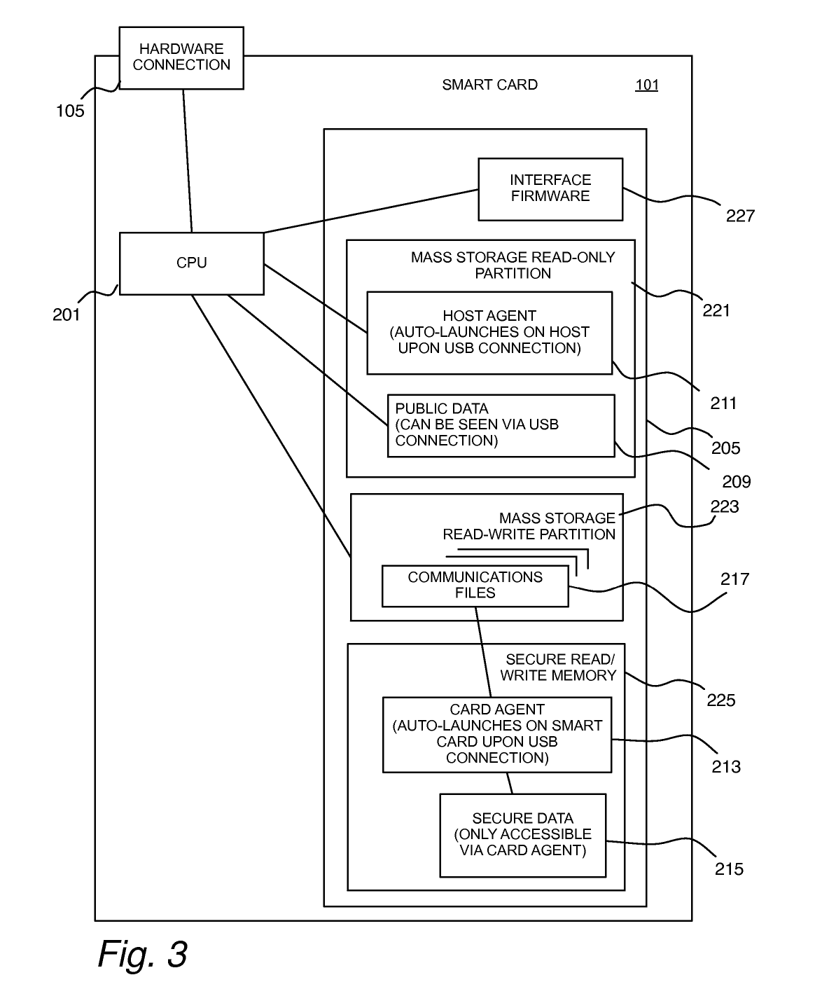

FIG. 3 is a block diagram illustrating the architectural organization of programs over the hardware components of the smart card 101. The hardware connection between the smart card 101 and the host computer 103 is achieved using the hardware connector 105. The communication on the hardware connection uses the USB mass storage protocol. The CPU 201, executing an interface firmware module 227, which is stored as firmware on the smart card 101, manages that communication. As such, the interface module is located in the non-volatile memory 205 or in Read Only Memory (ROM). The interface firmware module 227 implements the USB mass storage protocol such that the host computer 103 perceives the smart card 101 to be a USB mass storage device.

The non-volatile memory 205 of the smart card 101 contains three areas: a mass storage read-only partition 221, a mass storage read-write partition 223, and a secure read/write memory 225. The mass storage read-only partition 221 and the mass storage read-write partition 223 are accessible from external devices, e.g., the host computer 103. However, while external devices, e.g., host computer 103, can write to the read-write partition 205, in one embodiment, the read-only partition may be written to by the CPU 201 of the smart card 101, i.e., the read-only partition 203 is read-only with respect to external devices, but not necessarily to the smart card 101. Conversely, the secure read/write memory 225 may not be accessed directly from external devices for either read or write operations. Because all interactions are managed by the interface firmware 227, the interface firmware 227 can control access to various parts of the non-volatile memory 205 or files stored in the non-volatile memory 205 so that, for example, only the card agent 213 can access the secure data 215 (described herein below).

The mass storage read-only partition 221 contains public data 209 that may be accessed from any host computer to which the smart card 101 may be connected. The mass storage read-only partition 221 also contains a program, the host-agent 211, which is auto-launched on the host computer 103 when the smart card 101 is connected to the host computer 103 via the hardware connection 105. The USB mass storage standard provides that a USB mass storage device may include a trigger file called autorun.inf that is a script that automatically is executed when the device is connected to a host. Table I is a code example of one possible autorun.inf file to launch the host-agent 211:

TABLE 1
Example Autorun.inf to launch the host-agent 211.

[autorun]
shellexecute=hagent_r.exe
action=Launch the Network Card Host Agent
label=NetCard Host
UseAutoPlay=0

When a user 111 inserts the smart card 101 into the appropriate slot on a host computer 103, the operating system (e.g., Microsoft Windows) displays a dialog box allowing the user 111 to select the action “Launch the Network Card Host Agent”. If the user 111 accepts that action, the host-agent 211 (“hagent_r.exe” in the example code) is executed by the host computer 103.

The secure read/write memory 225 contains a module called the card-agent 213. The smart card 101 is configured such that, when the smart card 101 is connected to a host computer 103, i.e., when a USB connection has been established between the smart card 101 and the host computer 103, the CPU 201 launches (i.e., executes) the card-agent 213. As described in greater detail below, in one embodiment, the card-agent 213 is the only program through which certain secure data 215 may be accessed.

Typically a USB mass storage device is used to store data files. USB memory sticks are one example of a USB mass storage device. A USB memory stick functions as a very compact and easily transportable non-volatile storage device. A user uses such a device to store data files.

The mass storage files are files with public access that are exposed by the smart card 101 and visible from the host computer 103. The host agent 211 has direct access to these files. Examples of these files can be HTML, image, JavaScript, CSS files, as well as public key certificates. All files visible through the mass storage interface are read-only files for the host computer 103. The only exception is a set of communications files 217 in the mass storage read-write partition 223; for example, according to one embodiment of the invention, the communication channel between the host agent 211 and the card agent 213 is based of mass storage files. These files are read-write files.

Thus, to achieve a communication according to the USB mass storage protocol between the card-agent 213 and the host-agent 211, when the host-agent 211 is executing on the host computer 103, the card-agent 213 and host-agent 211 writes communication data files 217 in the mass storage read-write partition 223. The nature of that communication is described in greater detail herein below.

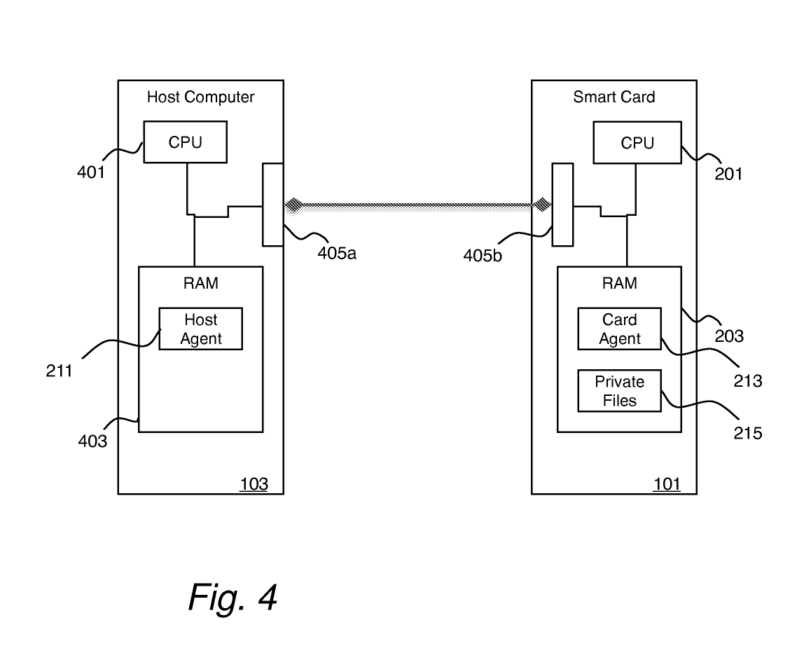

FIG. 4 is a block diagram illustrating the loading of the host-agent 211 into the RAM 403 of the host computer 103. The CPU 401 of the host-computer 103, then executes the host-agent 211. The host agent 211 communicates with the card-agent 213, which is loaded in the RAM 203 of the smart card 101 and executed by the CPU 201 of the smart card 101. Through the card agent 213, the host agent 211 has access to private files 215 that are stored on the smart card 101. Communication between the host agent 211 and the card agent 213 is performed via the host-side USB mass storage interface 405a and the card-side USB mass storage interface 405b (collectively, 405).

The architecture illustrated in FIGS. 1-4 provides a framework in which a smart card 101 can provide security and convenience of services for Internet applications. In one embodiment, the components involved rely solely on the USB mass storage interface for connectivity and do not require the smart card 101 to implement networking protocols, such as TCP/IP, DHCP server, or DNS server, in order to provide services. The architecture avoids the burden of implementing a network communications stack, DHCP server, or a DNS server on the smart card 101. In one class of solutions using a smart card 101, as described herein, dealing with authentication and secure Internet access, the smart card 101 may include the following components:
A smart card 101, capable of enumerating as a USB mass storage device and having an internal secure file system.
SSL/TLS library, in client and server mode
OATH, etc. for OTP
HTTPS web server
HTTPS agent
Application programs

The smart card 101 enumerates as a USB mass storage device and contains a private file system 215. The components used for providing security services may be split between the host computer 103 and the smart card 101. These components are divided between the smart card 101 and the host computer 103 into two main logical pieces, namely, those provided by the host agent 211 and those provided by the card agent 213. All functionality provided by connecting the smart card 101 is contained in these two main components, divided judiciously to suit a particular preference for security vs. performance trade-off. The two agents communicate with each other using a mass storage interface as an I/O channel. In one embodiment, the communication is encrypted by the two agents 211 and 213 to prevent access by a third party along a communications path from the smart card 101 to a remote server 109.

The actual division of workload between host agent 211 and card agent 213 is driven by the security versus performance considerations. On one end of the security/performance spectrum, the card agent 213 contains implementation of all the security components provided through the smart card 101 and the host agent 211 merely acts as a thin proxy. That solution is a very secure solution but may not have acceptable performance for certain classes of applications. On the other end of the spectrum all features are run on the host computer 103. That solution has excellent performance characteristics but offers little in way of security. The architecture provided herein offers flexibility in defining the right balance between security and performance.

The fundamental challenges of patching the host agent are insufficient memory space on the smart card and strict security requirements. The new mechanism proposed in this paper solves the memory problem by partitioning the host agent into smaller runtime components and addresses the security issue through a series of authentication, encryption, and verification safeguards. These techniques are described herein.

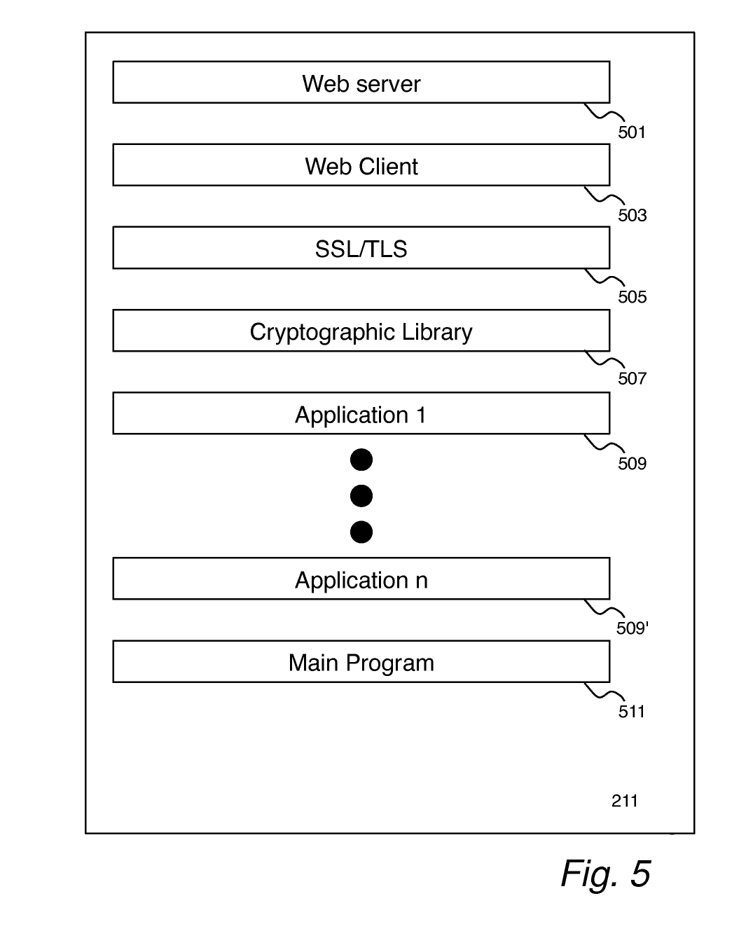

In a preferred embodiment, instead of being developed as a monolithic binary, the host agent is partitioned into a set of runtime components. FIG. 5 is a block diagram illustrating one example of such a partition of the host agent 211.
1. Web server 501.
2. Web client 503.
3. SSL/TLS module 505.
4. Cryptographic library 507.
5. A number of applications (services), where each application is regarded as a separate component, e.g., 509 and 509′.
6. Main program 511.

As a preliminary step to enable patching with limited memory (RAM and non-volatile memory) resource, the host agent into a main program 511 and several dynamically loadable libraries (for example, .dll or .so files) 501 through 509, step 601. Each functional component resides in a separate library. The main program 511 contains the entry point for the host agent 211, main( ), that loads the libraries 501 through 509′ and starts the host agent 211. The main program 511 also includes functionality to communicate securely with the card agent 213. Because the host agent 211 is launched from a smart card 101 and runs in a user's computer 103, the host agent 211 can be forced to dynamically load these libraries from the same location that the host agent 211 was launched from, i.e., the smart card 101. Patching the host agent 211 can now be achieved by patching one or more of these individual libraries 501 through 509′ or the main program 511. In this way, the additional space required on the smart card 101 for patching the host agent 211 is not the total size of the host agent 211, but rather the size of the largest individual component 501 through 511. Thereby, patching is possible, even for devices with extremely limited free memory space.

For convenience of this description, DLLs are used to represent dynamically loadable libraries in a platform independent manner. The actual file format of the dynamically loadable library partitions may be .dll, .so, or other formats.

The partition described above enables the patching of the host agent while using memory space that is only a fraction of the total host agent size. The host agent contacts the remote patching server over the Internet for availability of new components (DLLs or the main program).

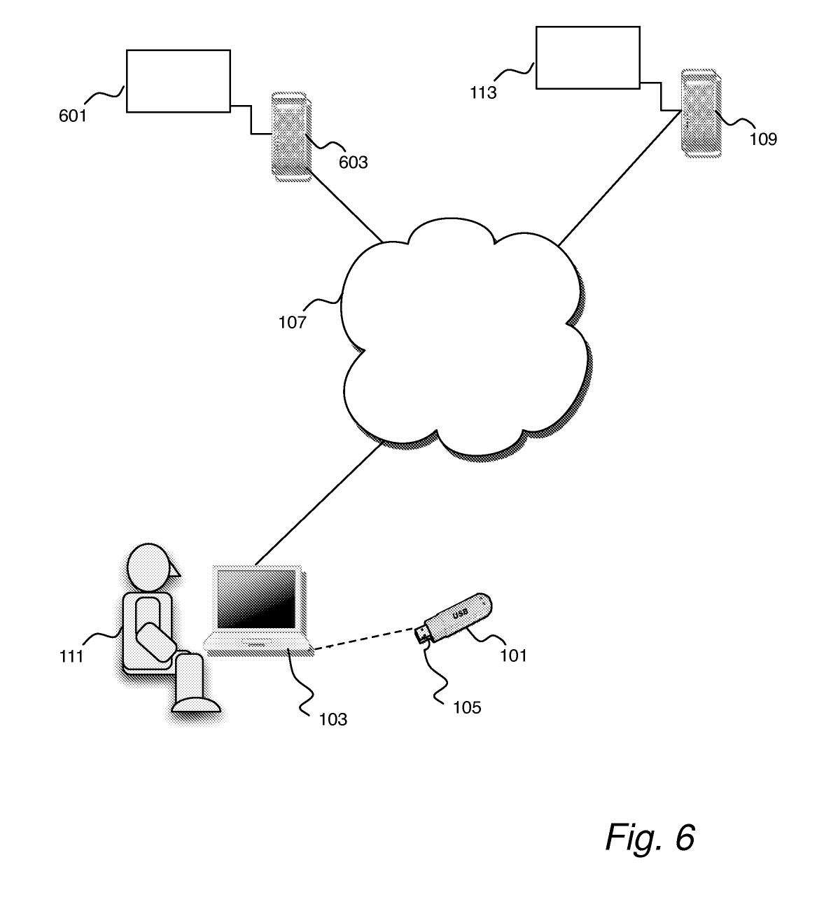

FIG. 6 is a block diagram illustrating an example scenario in which a smart card is used to access services on a remote server and in which a host computer, running a host agent 211 as described herein above, may retrieve patches from a patch server 201 running on a remote patch server computer 603.

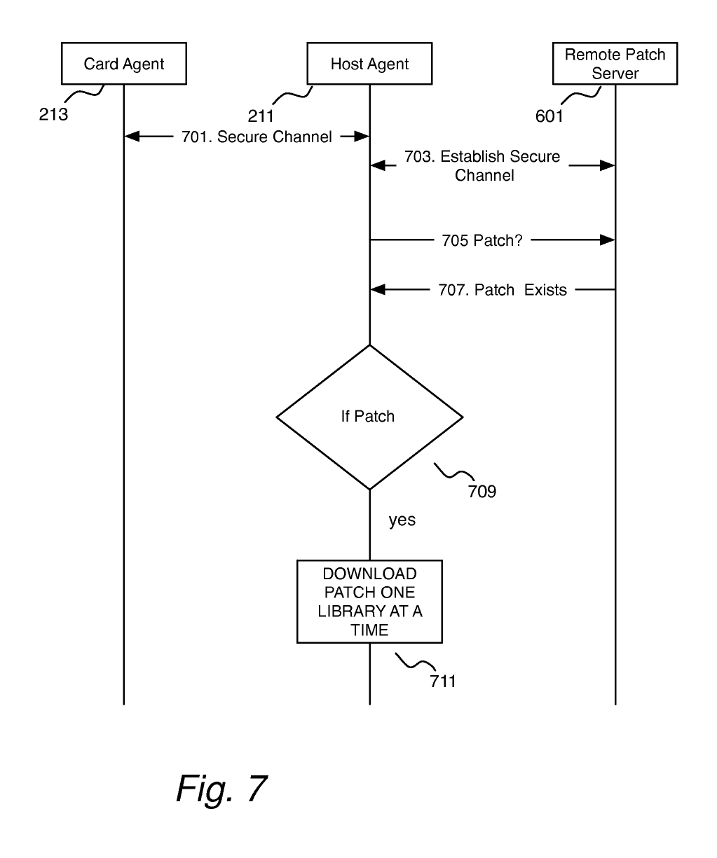

FIG. 7 is a timing sequence diagram illustrating the message flow between the remote patch server 601, the host agent 211 and the card agent 213 to achieve patching of the host agent 211.

As a preliminary step, e.g., as part of launching the host agent 211 on the host computer 103, a secure communications channel is established between the host agent 211 and the card agent 213, step 701.

To perform a patch, the host agent 211 establishes a secure SSL/TLS session with the remote patch server 601 via mutual authentication, step 703. The device certificate for this mutual authentication resides on the smart card 101, and is released only after the card has confirmed the validity of the host agent 211 (i.e., step 701). This verification mechanism, however, is beyond the scope of this paper. Through this secure channel, the host agent checks for new components and downloads them if needed. The patch server signs all patches to be downloaded using its private key.

Thus, in one embodiment, the host agent 211 may inquire if a patch exists by sending a query 705 to the remote patch server 601.

A patch may include one or more libraries, or the main program. If a patch exists, step 709, the patches are downloaded by the host agent 211, one library at time, step 711, and stored in a portion of the RAM 403 of the host computer 211 and subsequently downloaded to the smart card 101 as described herein below.

Due to the limitations of available memory space on the smart card, the patches are downloaded one component at a time. There are two approaches to actually replacing a component on the smart card: deferred replacement, and dynamic replacement. These approaches are described below.

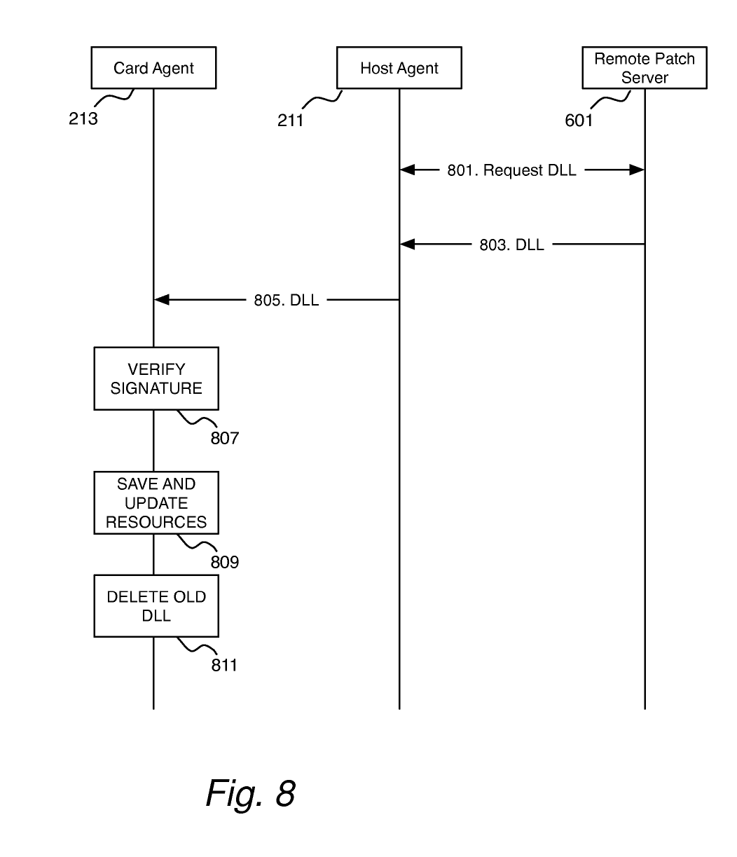

Deferred Replacement: In the Deferred Replacement approach, which is illustrated in FIG. 8, a patch is downloaded but not used until the smart card 101 is reset.

The host agent downloads a new DLL (or main program) from the remote server, steps 801 and 803. Next the host agent 211 transmits the DLL to the card agent 213 securely, step 805. The card agent 213 checks the signature of the DLL to ensure that the DLL is authentic, step 807. The card agent 213 saves the new DLL to non-volatile memory 205, e.g., in the secure data area 215, and updates resources associated with the DLL, step 809. The card agent 213 then deletes the old DLL from the NVM 205 to make room for the patch for a next DLL, step 811. At the next card reset, the loading of the host agent 211 will cause the loading the new DLL. The host agent 211 can use deferred replacement in the following situations:
1. A patch contains only one DLL or the main program.
2. A patch contains more than one DLL and/or the main program. In this case, the host agent downloads one component at a time and replaces the old one.

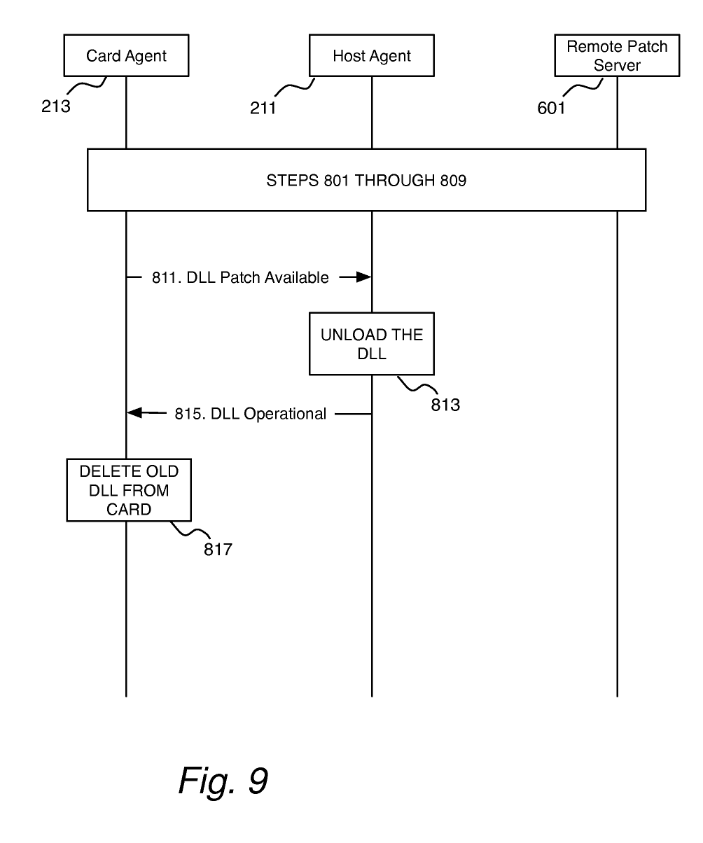

Dynamic Replacement: In the Dynamic Replacement approach, which is illustrated in FIG. 9, a patch is downloaded and then immediately used by the host agent 211. When updating DLLs the download and validation steps are identical to Deferred Replacement approach illustrated in FIG. 8 and described in conjunction therewith. However, once the download is complete, including the verification of authenticity, the card agent 213 informs the host agent 211 that the new DLL is available for use, step 811. The host agent 211 then unloads the DLL from the memory of the user's computer 103 and reloads the new DLL from the card, step 813. This effectively dynamically swaps out the old DLL with the new one. The host agent 211 may inform the card agent 213 when the host agent 213 has confirmed that the new DLL is operational. The card agent 213 does not delete the old DLL until the new one is operational, step 817. The Dynamic Replacement method allows the host agent to use new DLLs as soon as possible. The Dynamic Replacement method can handle patches with one or more DLLs, as long as the patch does not introduce inconsistency among the DLLs. This method cannot be used when updating the host agent 211 main program 511.

In one embodiment of the invention, consistency of the partitions, i.e., the DLLs, may be verified. Some updates may involve more than one library or even the main program. For example, a change in a common header file or a public interface may require update to the entire host agent. In such cases, a patch must include all components impacted by the change. This is to ensure consistency between the main program and its dependent DLLs, as well as consistency among the DLLs themselves. Otherwise, the host agent 211 may not run correctly or not run at all.

One method for managing the consistency relies on using a consistent version numbering scheme. In that embodiment, the libraries and the main program have their own version numbers. Moving along with each patch, the components involved increase their corresponding version numbers, respective. Because a patch may include one or more components, the version numbers becomes diversified. To ensure the consistency, the patch server 601 keeps track of version numbers of the libraries and the main program. Each patch contains updated components and their version number. The patch also lists compatible versions numbers of other components that are not in the patch. The card agent 213 also keeps track of the version numbers for the components for the host agent 211. The card agent 213 may keep the components version numbers and compatibility information in a table for that purpose.

While the host agent 211 is being patched, several unavoidable, or unexpected disruptions are possible. For example, a disruption may occur by the user removing the smart card from the smart card reader or due to the occurrence of a power outage. If changes have only completed partially, the file is in an unusable or inconsistent state. In smart card terminology this is called tearing. Tearing may occur during the host agent patching process. Methods to handle tearing in the context of updating a host agent 213 are described herein below.

If a patch involves only one DLL or multiple DLLs with no re-alignment of consistency, existing smart card anti-tearing mechanisms for updating normal files can be used. The card does not delete the old file until it validates the new one.

However, for a complex patch involving multiple partitions, is more difficult. Handling tearing is more difficult when a patch has more than one DLL with interdependency of the changes. For example, an interface change requires all DLLs using or defining this interface to be updated at the same time. If tearing happens after a card has only downloaded a subset of DLLs in a patch, the host agent may not be able to function correctly because of inconsistent interfaces between DLLs. In this case, the card agent may know that the tearing has happened. Therefore, the card agent handles the tearing and finish downloading the patch.

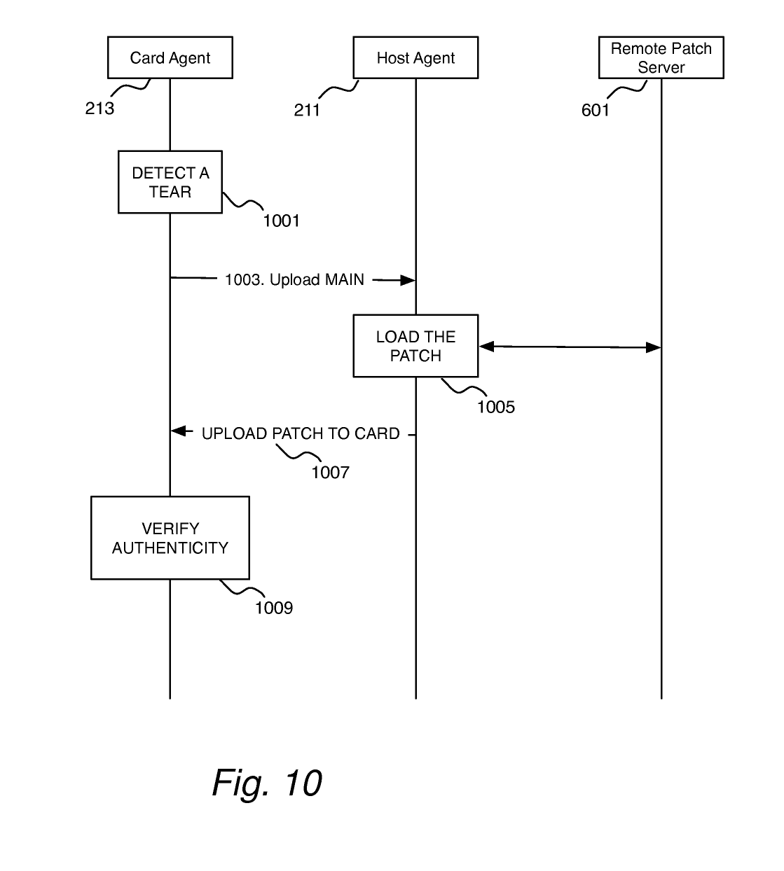

FIG. 10 is a flow-chart illustrating one embodiment for recovery from tearing.

First the card agent determines that a tear has occurred, step 1001. This may involve comparing the version numbers for each partition to the version numbers stored in the table of version numbers to determine if a compatibility issue exists. If a tear has occurred in which an incompatibility exits, it may be possible to proceed with only the main program.

The main program itself can run from the card without loading any DLL. Therefore, the main program 511 is loaded to the host agent, step 1003. If the DLL transport security requirements and card/host communication security requirements are not strict, the main program 511 can contact the remote server to finish loading the patch, steps 1005 and 1007. If a patch includes the main program the version of the main program that is available after tearing will either be the old version or the new one depending upon the timing of tearing. This, however, does not cause any problem because the main program can always load a new version of itself if needed. The card agent checks the signature of each downloaded component to make sure it is from a pre-qualified patch server, step 1009. If the signature verification is successful the component is accepted, otherwise it is dropped.

If the card agent 213 must implement strict security, the card agent 213 does not talk to a host agent or any host program without authentication and a secure channel. The method of loading the main program 511 only to the host computer may not work because the main program may not be able to work with inconsistent SSL/TLS or crypto DLLs. In this case, the host agent 211 patching uses the following methods to handle tearing.

In an alternative embodiment, the smart card 101 may contain a backup loader stored in the NVM 205, whose only function is to securely download patches. If the main program 511 cannot run correctly, the backup loader can perform the patch download. However, this method consumes additional non-volatile memory on the card.

In a further alternative embodiment, the host agent 211 which the host agent 211 obtains, for example, from the remote server 601 or 113.

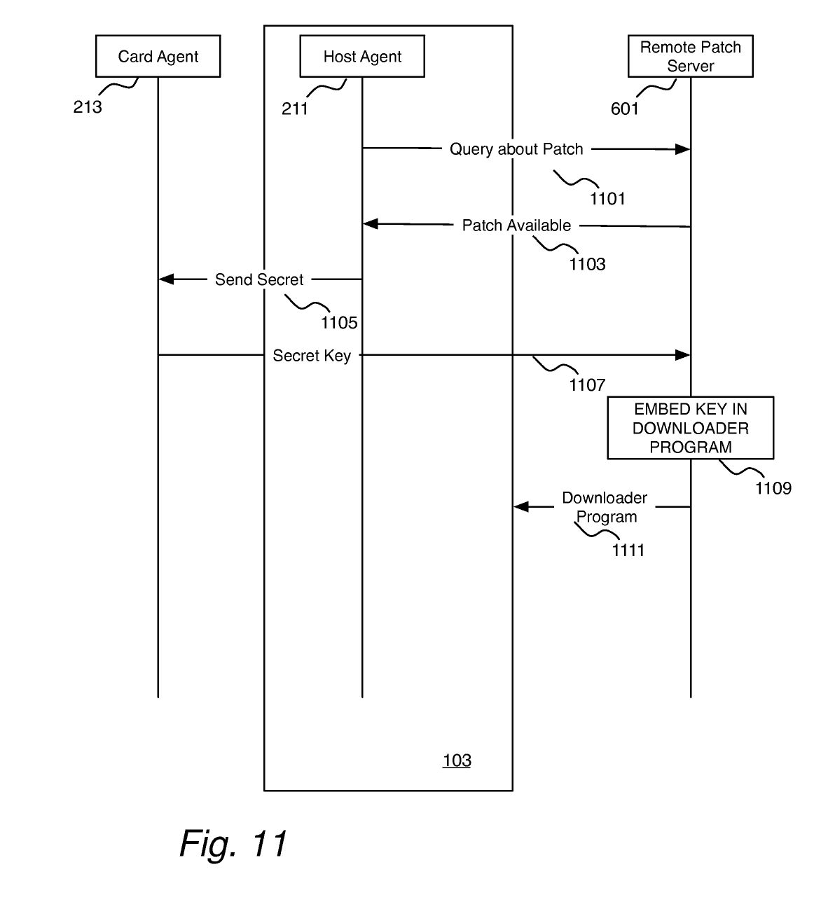

When the host agent 211 learns from the patch server 601 about a major patch, in which new DLLs are not compatible with the old ones, the host agent 211 can use a downloader program (downloader) from the patch server 601 to perform the update. FIG. 11 is a timing sequence diagram illustrating the customization of the downloader program for use with a particular card.

As an initial step, the host agent 211 inquires the remote patch server 601 as to the availability of a patch, step 1101, and obtains an indicator that a patch is available, step 1103. (Naturally, the converse can occur that no patch is available; in which case there is nothing for the host agent 211 to do related to obtaining a patch. This scenario is not explicitly illustrated.)

In response to an indication that a patch is available, the host agent 211, through the card agent 213, sends a random secret key (download key) to the patch server 601 through the established SSL/TLS channel. For example, the host agent 211 may send a message 1105 to the card agent 213 to send a secret key to the remote patch server 601, and the card agent 213 responds by sending the secret key to the remote patch server 601, step 1107. The patch server 601 then embeds the download key in the downloader program, step 1109. Thus, the particular instance of the downloader program is customized to be associated with a particular card agent 213, and consequently, with a particular smart card 101.

In relation to using the downloader program, the host agent 211 instructs the user to do the following:
1. Get the downloader program from the patch server and save it on the local computer, step 1111. Each instance of the downloader is customized to communicate with a particular card agent 213.
2. Stop/terminate the host agent executable. The exact steps for doing this are platform specific, but can be easily conveyed to the user. For example, on Windows the user can be given instructions to use Windows Task Manager to “end” the host agent process.
3. Start the downloader program on the host computer 103.

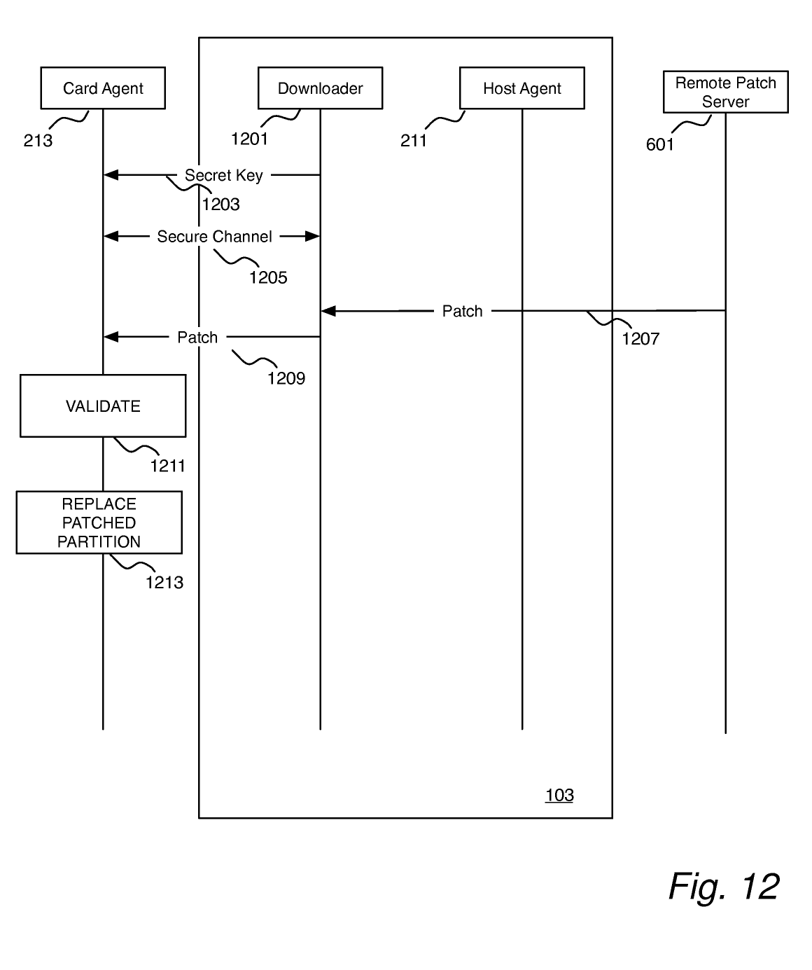

Once started the downloader program performs the following, the operation of which is illustrated in the timing sequence diagram of FIG. 12:
1. The downloader instance 1201 authenticates itself to the card agent 213 using the download key that originally came from the card agent 213, step 1203. As stated earlier, each downloader program instance 1201 is customized based on the download key provided by the smart card 101. This download key becomes the initial secret seed between the card agent 213 and the downloader 1201, and may be used to bootstrap secure communication between them. The bootstrap process is possible since the download key originates from the card 101. This is similar to the way host agent 211 and card agent 213 communication is secured.
2. The downloader instance 1201 establishes a security channel with the card, initially using the download key, and later using the derived session keys, step 1205.
3. The downloader instance 1201 obtains the update patch from the patch server, step 1207, and transfers the patch to the card, step 1209. This may be performed in the same manner as the main program of the host agent obtains patches.

The card agent validates the signature of the downloaded component, step 1211, and replaces the old version of the patched partition on the card, step 1213. If a tearing occurs during this step, the card agent 213 does not need to generate a new download key. This is because the downloader 1201 is still on the user's computer and the user can restart the update process by inserting the card and starting the downloader 1201.

In the event that none of these patch update methods work, the user can take his smart card token to a service shop to refurbish the card. The card can get a brand new host agent through the personalization channel, for example, the ISO 7816 channel.

In an embodiment of the invention, the patching operations of host agent 211 are performed in a manner to ensure the security of the card 101 and the information stored in the card 101. The security mechanisms described in the co-pending patent application Ser. No. 11/564,121 are also applicable to the host agent partitioning mechanisms described herein, and are, therefore, not repeated here.

In one embodiment of the invention the smart card 101 enforces access control to restrict access to its resources and data. In that embodiment, a user must login to the card 101 in administrator role in order to be allowed by the card 101 to perform host agent patching.

In one embodiment of the invention, mechanisms are put in place to prevent misuse of the host agent, for example, unauthorized copying, modification, or execution by a malicious user.

In a first alternative, the host agent 211 (main program 511 and DLLs 501 through 509′) are stored in the smart card 101. When a user inserts his card, the host agent 211 appears in a USB Mass Storage device interface of the card 101 as presented on the user interface of the host computer 103. From the perspective of the host computer 103 what is presented is a disk drive that is read-only. Keeping the smart card 101 as a read-only device prevents direct modification of the code by malicious applications running on the host PC 103.

In an embodiment, after the card 101 is inserted into the host 103 (or otherwise made to connect with the host 103), and the host agent 211 is started, i.e., loaded from the card 101 and launched on the host computer 103, the host agent 211 may report its status to the card agent 213. For example, once the host agent 211 has successfully loaded all the required DLLs 501 through 511, the card agent 213 can restrict all future access to the host agent files. This can be done in one of two ways: by removing the host agent files (main program and DLLs) from the Mass Storage device interface so that they are not visible from the host computer 103, or ignoring all subsequent requests to read from the host agent files. This can prevent malicious users from manually copying the host agent code to the hard disk of the host computer 103 for offline analysis, or executing another version of the host agent 211. The card agent 213 may inform the user via the host agent about malicious activities toward host agent files.

In an embodiment of the invention, the authenticity of the host agent is guarded by operating the host agent 211 and card agent 213 to download update patches solely from an authenticated patch server 601 through a secure channel. Each patch is signed by a secret key known only to those authorized to provide patches, and the card agent 213 checks the signature to ensure the authenticity of the patch. The trusted key may be pre-stored in the secure data file 215 guarded by the card agent 213. Therefore, as long as the patch key has not been compromised, even if the communication channel were somehow compromised, the card 101 would not accept a fraudulent patch because the fraudulent patch would not have the correct signature.

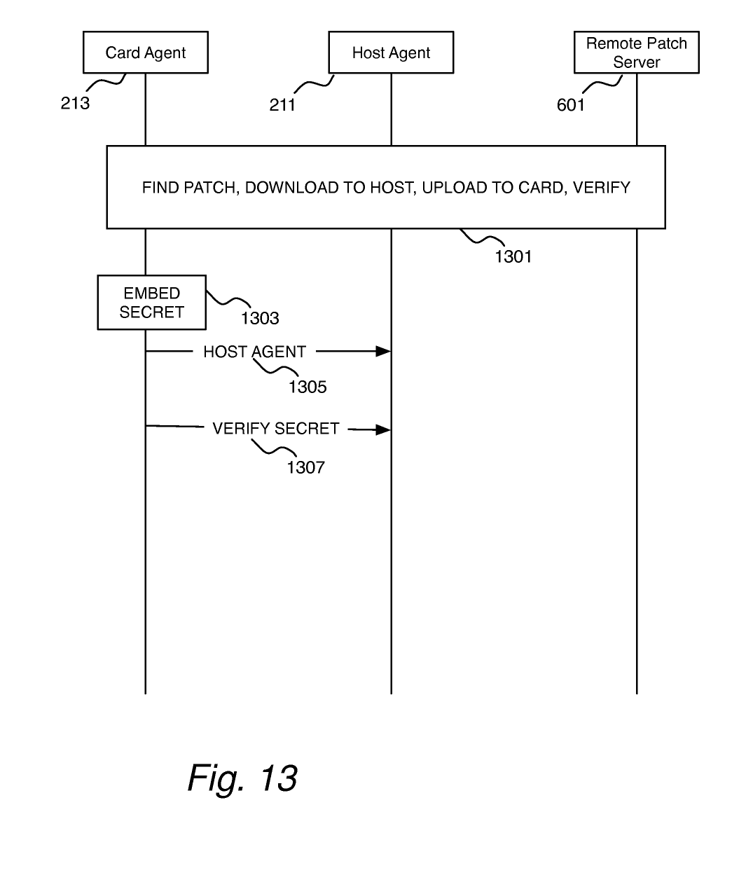

The security mechanisms described in co-pending patent application Ser. No. 11/564,121 such as embedding secret and computing hash values, apply to the partitioned host agent as well. FIG. 13 is a timing sequence diagram illustrating the mechanism of using embedded secret hash values to verify the authenticity of the host agent 211 and the partitions that make up the host agent 211. After the steps that culminate in uploading the patches to the card 101 as described herein above, step 1301, the card agent 213 embeds a random secret in the host agent main program 211, step 1303, for example, at each card reset or each time the main program is loaded from the card 101. The card agent 213 then uses this secret and its derivatives to authenticate and to secure communications with the host agent 211, step 1307. The verification may be performed periodically.

The card also uses pre-computed hash values at some chosen offsets of the host agent main program file 511 to periodically check the host agent 211 authenticity at runtime. When patching the host agent main program, the remote server provides a list of pre-computed hash values to the card for such thumbprint checking.

When the user's computer has autorun enabled, the host agent 211 runs automatically on the host computer 103 after card insertion. The host agent 211 loads DLLs from the local directory, that is, from the read-only Mass Storage disk of the smart card 101. As discussed herein above, the card agent 211 authenticate the DLLs after downloading them. Because the disk is read-only, no application outside the card can directly modify these DLLs. All such modifications have to flow through the communication channel established between the host agent 211 and the card agent 213. This enables the card 101 to enforce safeguards related to host agent 211 updates. Therefore, the DLLs loaded by the host agent 211 are verified to be authentic.

If the user (or the administrator) has disabled autorun on the host computer 103, the host agent 211 cannot run automatically. In that case, the user would manually run the host agent 211, for example, by double clicking a file link in a Windows Explorer window. If there is malicious software on the user's computer 103, that malicious software could potentially copy the host agent 211 and all the associated DLLs from the Mass Storage interface of the smart card 101 to a local disk before the user runs the host agent 211 from the smart card 101. The malicious software could then run the host agent 211. In that situation, the card 101 cannot tell if the legitimate user or a malicious program is running the host agent 211. Furthermore, neither the user nor the card agent 213 would know from which location the host agent 211 is being launched. If the malicious program merely copies and runs the host agent 211, no damage would be caused. The malicious program in fact plays the role of the autorun function. If, however, the malicious code changes the host agent 211, problems may occur.

If the malicious software changes the host agent's main program, in one embodiment, the card agent 213 can soon discover this manipulation of the host agent 211 by requesting hash values and checking then against pre-computed reference values. If the malicious software spoofs the main program, obfuscation mechanisms described in co-pending patent application Ser. No. 11/564,121 make it very difficult and time consuming to reverse engineer the code. It is not easy to find out secret key and the hash values of the host agent in order to communicate with the card agent. Therefore, the host agent is well protected against malicious applications on the PC.

The attacker might resort to hacking DLLs by spoofing one or more of them. To solve this problem, the host agent 211 may be able to tell if a DLL comes from the smart card 101 or from another location on the host computer 103 (or another connected disk device). The following method enables the host agent to do so.

Assume the host agent's main program is the true one. After starting up, the main program 511 checks its own absolute path. Before loading each DLL, the main program 511 uses the path of that DLL to check a file attribute of the DLL file; for example, a time stamp. If the request goes to the smart card 101, the card returns a random secret that either the host agent 211 knows or the genuine DLL knows. The host agent 211 loads the DLL only if the returned value corresponds to the expected value. If the request goes to a file system, e.g., a disk on the host computer 103, the latter returns the actual file attribute. However, since the secret value held by the host agent 211 is not that actual file attribute, the host agent 211 can determines that the DLL is not from the smart card 101. In response to that determination, the host agent 211 refuses to load the bogus DLL and warns the user that his computer has been compromised.

Although a signature check of the DLL would ensure the authenticity, the host agent 211 may not be able to perform a signature check prior to loading the DLLs. For example, the host agent 211 may not be able to perform a signature check before loading the crypto DLL 507.

In one embodiment, communication security is relied on as one aspect of protecting the smart card 101 from attacks and in protecting confidential information on the smart card 101. The communication method and the communication security measures described in co-pending patent application Ser. No. 11/564,121 apply to the partitioned host agent as well. Because the host agent's main program has more security features than the DLLs do, all communications to the card go through the main program.

In one embodiment, the main program 511 contains a function table that contains pointers to functions that the DLLs can use when communicating with the smart card 101. After the main program 511 loads a DLL, the main program 511 calls an init( ) function in the DLL. One argument to this init( ) function is a pointer to the function table. When a DLL communicates with the card, the DLL uses one or more functions in this table. The main program 511 thus controls all communications to the card.

In general, each program in a computer 103 loads DLLs into its own image space. For example, if two programs load the same DLL, the DLL has two copies in the computer's RAM, wherein each copy resides in the image space of its respective program. Any change in the state of one DLL does not affect the other. Therefore, even if a malicious program loads a DLL of a host agent, that malicious program cannot go through the genuine host agent 211 to communicate with the card agent 213. In addition, the card agent prevents a second read to the host agent main program and DLLs.

From the foregoing it will be apparent that software application that is stored on a smart card and partitioned into a plurality of partitions may be updated, i.e., patched on the smart card even if the overall memory resource on the smart card is not sufficiently large to accommodate a complete extra copy of the software application. By having the software application, e.g., a host agent, and a card agent that cooperate to provide secure communication between a host computer and a smart card while maintaining the security of sensitive information stored on the smart card provides an efficient and secure approach to using the power of smart cards to ensure that the software application, while being patched, is not subject to tampering. The solution furthermore provides for recovery against tearing during patching.

Although specific embodiments of the invention have been described and illustrated, the invention is not to be limited to the specific forms or arrangements of parts so described and illustrated. The invention is limited only by the claims.

We claim:

1. A method for operating a computer to use a software application stored in a smart card to update the software application stored on the smart card, comprising:
partitioning the software application into a plurality of modules including a main program module;
loading the software application from the smart card into the memory of a host computer to which the smart card is connected;
executing the software application on the host computer;
using the instructions of the software application:
to establish a first communications channel between the software application and a remote patch server containing a patch for at least one partition of the software application;
detecting that a patch is available for the at least one partition of the software application;
downloading the at least one partition from the remote server into volatile memory allocated to the software application on the host computer via the first communications channel; and
uploading the at least one partition from the volatile memory allocated to the software application to the smart card.

2. The method of claim 1 further comprising operating a trusted entity to sign the patch for the at least one partition of the software application.

3. The method of claim 2 further comprising operating the smart card to verify the authenticity of the signature applied to the patch for at least one partition of the software application.

4. The method of claim 1 further comprising:
deleting a partition being patched, and corresponding to the patch, after the patch for the at least one partition has been uploaded to the smart card.

5. The method of claim 1 wherein the patch is loaded onto the host computer on a next reset of the smart card.

6. The method of claim 1 further comprising:
operating the smart card to inform the software application after correct validation of the patch;
deleting code corresponding to a portion to be replaced from the host computers memory; and
uploading the patch from the smart card.

7. The method of claim 1 wherein the step of detecting reveals that a patch is available for each of a plurality of partitions, the method further comprising:
for each available patch partition:
repeating the steps of downloading the partition and uploading the partition; and
deleting a partition being patched, and corresponding to the patch, after the patch for the partition has been uploaded to the smart card.

8. The method of claim 7 further comprising:
upon reset of the smart card:
checking for an inconsistency between the various partitions of the software application;
upon detecting an inconsistency:
determining the partitions that require patching to correct for the inconsistency; and
for each partition requiring patching:
performing the steps of downloading to the software application on the host computer, and uploading the patch for that partition to the smart card.

9. The method of claim 7 further comprising:
checking for availability of a patch including updates for a plurality of partitions that are all required to ensure operability of the software application;
upon detecting the availability of a patch including updates for a plurality of partitions that are all required to ensure operability of the software application, executing a downloader program on the host computer wherein the downloader program has embedded therein a unique secret key linking the downloader program with a particular smart card, the execution of the downloader program causing the host computer to:
transmit the unique secret key embedded in the downloader program to the smart card;
successively obtaining the updates for the plurality of partitions that are all required to ensure operability of the software application and uploading the plurality of partitions to the smart card; and
operating the smart card to authenticate the downloader program by verifying that the transmitted secret key corresponds to a key expected by the smart card.

10. A smart card for use with a host computer, the smart card having a software application stored thereon and operable to update the software application stored on the smart card when executed on the host computer, the smart card comprising:
a non-volatile memory wherein the software application is stored thereon as a plurality of module partitions including a main program module;
wherein the software application comprises instructions that when loaded and executed on the host computer causes the host computer:
to establish a first communications channel between the software application and a remote patch server containing a patch for at least one partition of the software application;
to detect that a patch is available for the at least one partition of the software application;
to download the at least one partition from the remote server into volatile memory allocated to the software application on the host computer via the first communications channel; and
to upload the at least one partition from the volatile memory allocated to the software application to the smart card.

11. The smart card of claim 10 further comprising a card agent software program executable on the smart card and comprising instructions to cause the smart card to verify the authenticity of a signature applied to the patch for at least one partition of the software application wherein to be approved the signature should correspond to a trusted entity.

12. The smart card of claim 10 wherein the card agent software program further comprises instructions to cause the smart card to:
delete a partition being patched, and corresponding to the patch, after the patch for the at least one partition has been uploaded to the smart card.

13. The smart card of claim 10 wherein the patch is loaded onto the host computer on a next reset of the smart card.

14. The smart card of claim 10 wherein the card agent software program further comprises instructions to cause the smart card:
to inform the software application after correct validation of the patch;
to delete code corresponding to a portion to be replaced from the host computers memory; and
to upload the patch from the smart card.

15. The smart card of claim 10 wherein the software application further comprises instructions to cause the host computer to if the operation to detect patches reveals that a patch is available for each of a plurality of partitions, to for each available patch partition:
repeating the operation of downloading the partition and uploading the partition; and
wherein the card agent software program comprises instructions to delete a partition being patched, and corresponding to the patch, after the patch for the partition has been uploaded to the smart card.

16. The smart card of claim 15 wherein the software application further comprises instructions to cause the host computer:
upon reset of the smart card:
to check for an inconsistency between the various partitions of the software application;
upon detecting an inconsistency:
to determine the partitions that require patching to correct for the inconsistency; and
for each partition requiring patching:
to perform the steps of downloading to the software application on the host computer, and uploading the patch for that partition to the smart card.

17. The smart card of claim 15 wherein the software application further comprises instructions to cause the host computer to:
check for availability of a patch including updates for a plurality of partitions that are all required to ensure operability of the software application;
upon detecting the availability of at least one patch including updates for a plurality of partitions that are all required to ensure operability of the software application, to execute a downloader program on the host computer wherein the downloader program has embedded therein a unique secret key linking the downloader program with a particular smart card, the execution of the downloader program causing the host computer to:
transmit the unique secret key embedded in the downloader program to the smart card;
successively obtaining the updates for the plurality of partitions that are all required to ensure operability of the software application and uploading the plurality of partitions to the smart card; and
wherein the card agent program further comprises instructions to cause the smart card to authenticate the downloader program by verifying that the transmitted secret key corresponds to a key expected by the smart card.
